(19) United States
(12) Patent Application Publication
(10) Pub. No.: US 2005/0087214 A1
(43) Pub. Date: Apr. 28, 2005

(54) Single-conveyor elongated object cleaning system

(76) Inventors: Gilbert F. Ransley JR., McFarland, WI (US); Shawn W. Fogel, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 10/692,890

(22) Filed: Oct. 24, 2003

(51) Int. Cl. B08B 3/04

(52) U.S. Cl. 134/25.1; 134/32; 134/133; 134/122 R; 134/64 R

(57) ABSTRACT

A system for cleaning elongated objects uses a single inclined conveyor with a lower end adjacent a back stop disposed inside a tank containing cleaning solution. The elongated objects pile up between the back stop and the conveyor and a jet manifold sprays a lower side of the pile where pusher flights on the conveyor pick off the objects one at a time. A flip back plate strips the objects from the conveyor to continuously circulate the objects in the cleaning solution from the bottom to the top of the pile. The plate is retracted to allow the conveyor to deliver the objects to a rinse water basin where the clean objects are rinsed and then removed.

### CROSS-REFERENCE TO RELATED APPLICATIONS

Not applicable.

### STATEMENT OF FEDERALLY SPONSORED RESEARCH OR DEVELOPMENT

Not applicable.

### BACKGROUND OF THE INVENTION

1. Field of the Invention

The present invention relates to a system for washing elongated objects. More particularly, it relates to a system for washing sticks or rods which have been used for cooking and/or chilling food products.

2. Background of the Art

In the processed meats industry, products such as hotdogs and sausages are typically suspended in link form from stainless steel sticks or rods for cooking and chilling. The sticks are usually three to four feet long and are either tubular or have a V-shaped cross-section. Following removal of the product from the sticks, the sticks must be cleaned before being reused.

Typically, such sticks are cleaned using large drum-type washing machines. Such washers usually consist of a round or octagonal shaped drum with a side access door. The drum can be supported in a vessel by a drive shaft. The sticks are manually placed in the drum and the drum is rotated in a cleaning solution. This produces some tumbling action between the sticks but tends to confine and block cleaning solution from effectively penetrating the core of the stick load in the drum. Further, the sticks with the V-shaped cross-section are prone to bunching and nesting which limits any mixing or migration of the sticks through the drum. Also, cleaning solution must be dumped after the wash cycle to allow refilling the unit with rinse water.

Another prior art apparatus for treating rods and pipes is disclosed in J. Moltrup, U.S. Pat. No. 1,393,633. The system disclosed in this patent includes a machine divided into separate pickling and washing compartments. The rods are organized into bundles or bunches and each bundle is inserted into a carrier. The carriers are placed on a runway which conveys the carrier into each compartment. As each carrier reaches the lower end of the runway, it is caught by a conveyor with flights and conveyed out of the first compartment. The carrier is passed through subsequent compartments, each with its own conveyor. One drawback of this system is the need for multiple conveyor assemblies. Another problem is that the rods must be placed in individual carriers and must be moved therefrom after exiting the apparatus. Also, there is no provision in the individual carriers for insuring that the rods and sticks are well mixed.

Another washing apparatus is disclosed in W. Morgan, U.S. Pat. No. 1,751,838. This apparatus is used for preparing cane stalks. The cleaning tank is provided with a hopper having inclined ends which direct the cane stalks onto a looped-shaped conveyor located adjacent to the bottom of the hopper. Another conveyor which shares a shaft with the loop-shaped conveyor conveys the cane stalks out of the hopper. Each of the conveyors is provided with a series of fingers which positively moves the cane stalks from the infeed of the hopper to the outfeed of the hopper. Like the previously described prior art washer, this system requires multiple conveyors. Another drawback of this system is that the cane stalks can short circuit the desired tumbling action in the circular conveyor by being removed too soon by the outfeed conveyor.

Another washing apparatus is disclosed in Ransley et al., U.S. Pat. No. 5,778,907, which is assigned to the assignee of the present invention and hereby incorporated by reference as though fully set forth herein. This patent discloses a conveyor washer specifically designed to improve the efficiency of washing the sticks or rods used by the food processing industry. Here, two conveyors are used, each with two spaced apart continuous loop chains. An infeed conveyor slopes down from one end of the tank toward the bottom of the tank where an outfeed conveyor slopes upwardly toward the other end of the tank. The conveyors run simultaneously and are positioned at a prescribed included angle so that the infeed conveyor drives the pile of sticks toward the outfeed conveyor which has pusher flights that carrying the sticks upward individually. A flip back plate strips the sticks from the outfeed conveyor so that the objects circulate in the wash tank. When the wash cycle is complete, the flip back plate can be retracted so the sticks can be conveyed by the outfeed conveyor to a rinse tank. This system provides for efficient loading and unloading of the sticks as well as promotes effectively cleaning by separating and recirculating the sticks during the wash cycle. However, the disclosed system requires two separate conveyors, like the other prior art washers described above, and must be placed relative to each other at the proper angle. If the angle is too large, the infeed conveyor will not effectively deliver the sticks to the outfeed conveyor and if the angle is to small the sticks may become lodged and jam one or both of the conveyors, particularly since the infeed and outfeed conveyors act on the stick pile in opposite directions. This two conveyor system thus adds to the complexity, cost and maintenance of the washer.

### SUMMARY OF THE INVENTION

The present invention provides a washing system that effectively cleans elongated objects without the stagnant zones common in the prior art. It provides efficient loading and unloading of the elongated objects and allows the cleaning solution to be reused for subsequent loads. The present invention provides such a system with reduced cost and complexity compared to multi-conveyor systems.

In particular, one aspect of the present invention provides an apparatus for cleaning elongated objects having a cleaning tank, of the size necessary to hold the elongated objects in a cleaning solution, defining a feed end and an exit end formed by a top, a bottom and side walls and containing a back stop and an inclined conveyor. The back stop is mounted inside the tank at the feed end and extends in the direction between the top and bottom of the tank. The conveyor is mounted inside the tank with its lower end adjacent the back stop and so it slopes upwardly in the direction from the tank bottom to the exit end so as to convey the elongated objects from the feed end to the exit end.

During a cleaning cycle several elongated objects are loaded into the tank. The elongated objects pile up between the back stop and the conveyor. The conveyor strips off the lower, adjacent layer of elongated objects in the pile one at a time and circulates them through the cleaning solution. The elongated objects are thus pulled from the bottom side of the pile and returned to the top side. While piled and as they are beginning up the conveyor, a jet manifold provides a pressure spray that agitates and cleans the elongated objects. The weight of the pile holds the sprayed elongated objects down somewhat so that a forceful spray can be directed at the elongated objects without them being pushed away from the conveyor. While the true dynamics of the pile of elongated objects is somewhat unclear, the inventors have realized that it is important for the elongated objects to pile up as well as be circulated from bottom to top of the pile in order to achieve proper cleaning. The angle of incline of the conveyor and the included angle between the conveyor and the back stop are critical to avoid pockets of stagnation and achieve proper circulation of all the elongated objects.

Preferably, the back stop is essentially perpendicular and the conveyor is essentially at a 45° angle to the tank bottom. The back stop and conveyor thus extend along intersecting planes defining an angular section therebetween. Preferably, the included angle is between about 35° to about 60°, or more preferably of about 40° to about 50°, and even more preferably of about 45°, with the small angle between the conveyor and the tank bottom being preferably no less than 35°.

In other preferred forms, the tank includes separate wash and rinse basins and utilizes a single overflow sump, disposed between the basins, to limit disparate maximum water levels in each. A load ramp is mounted inside the tank at the feed end and slopes downwardly so that objects can readily slide down between the back stop and the conveyor. The conveyor itself preferably has two spaced apart chains. The chains include sets of aligned pusher flights extending from the conveyor at an angle. A flip back plate is mounted between the chains of the conveyor and is movable between a retracted position and an extended position. In the extended position, the plate is above the conveyor, and preferably, above a maximum fill level of the cleaning solution, which is regulated by an overflow.

In another aspect the invention provides a method of cleaning elongated objects comprising: feeding the elongated objects to the above described apparatus; operating the conveyor with the plate in the extended position for a predetermined time; and delivering the elongated objects to a rinse tank at the exit end of the tank by placing the plate in the retracted position; and removing the elongated objects from the rinse tank.

The objects and advantages of the present invention will be apparent from the description which follows. The following description is merely of a preferred embodiment. Thus, the claims should be looked to in order to understand the full scope of the invention.

### BRIEF DESCRIPTION OF THE DRAWINGS

FIG. 1 is a side elevational view of the single conveyor washer apparatus according to the present invention;

FIG. 2 is a top plan view thereof;

FIG. 3 is another side elevational view thereof opposite the side shown in FIG. 1;

FIG. 4 is an exit end view thereof;

FIG. 5 is a typical longitudinal cross-sectional view thereof;

FIG. 6 is a partial cross-sectional view thereof taken along the line 6-6 of FIG. 5;

FIG. 7 is a fragmentary enlarged detail of the flip back plate assembly; and

FIG. 8 is a cross-sectional view taken along line 8-8 of FIG. 6.

### DETAILED DESCRIPTION OF THE PREFERRED EMBODIMENT

The present invention provides an apparatus and method of washing elongated objects, such as tubular and V-shaped food processing sticks, that is an improvement over the drum and multi-conveyor type machines of the prior art. The washer of the present invention can clean and rinse the objects as well as or better than prior art machines with less complex sub-assemblies, thereby saving cost and reducing maintenance.

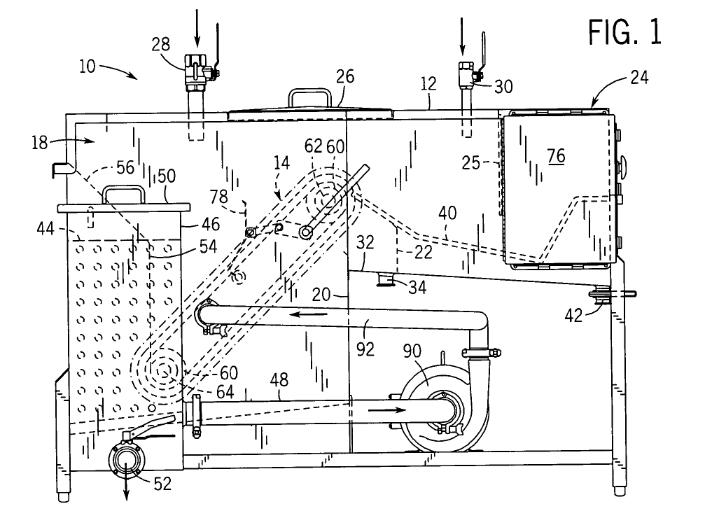

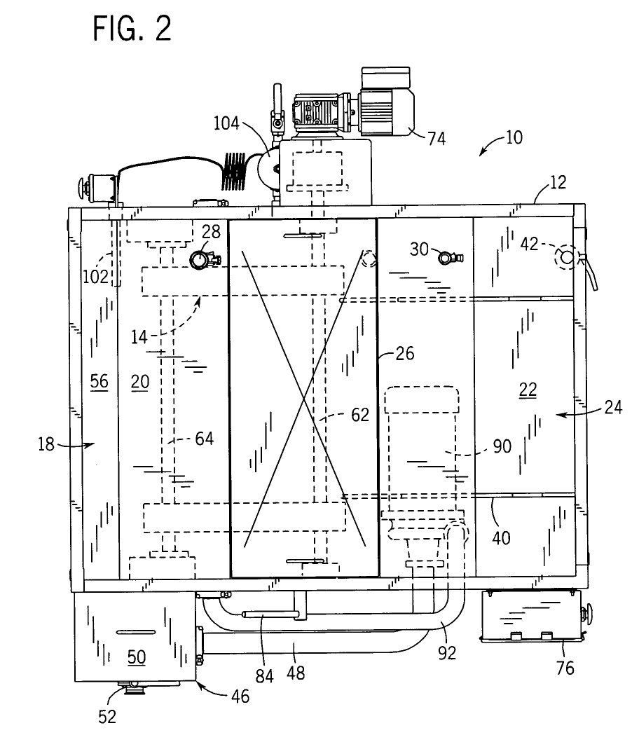

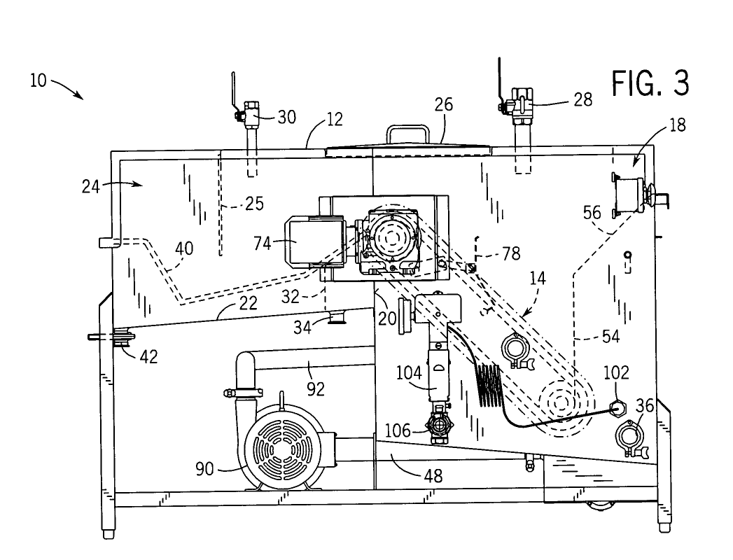

Referring to FIGS. 1-5, in this washer 10, a tank vessel 12 defining a top, a bottom and side walls, in general constructed of 304 stainless steel, contains a single conveyor 14 that circulates the elongated objects (“sticks”) 16 loaded into the vessel 12 from an open feed end 18 within a wash basin 20 for a period of time before carrying the objects to a shallower rinse basin 22 at an open exit end 24. The opening at the exit end 24 is preferably shielded by a strip curtain 25 depending from the top of the vessel 12 to retain heat and steam during the wash and rinse cycles. If desired, a second curtain (not shown) could be similarly mounted at the feed end 18. The vessel 12 is designed to accommodate sticks 16 having a typical length of 36-48 inches long. However, the apparatus can be modified in obvious ways to accommodate sticks of any size. The top of the washer 10 is equipped with a cover 26 which may be removed for easy access to the internals of the vessel 12. The level of the cleaning solution in the wash basin 20 and the level of rinse water in the rinse basin 22 is maintained by respective wash 28 and rinse 30 fill nozzles and an overflow sump 32 formed between the basins 20 and 22 and drained through a drain 34 leading to an exterior drain (not shown). If desired, the wash basin 20 may be drained via drain 36 (see FIG. 2). Sticks 16 are discharged into the rinse basin 22 by falling off the conveyor 14 and onto a rinse rack 40, which sits on the bottom of the rinse basin 22. The rinse basin has a drain 42 at its bottom. A removable perforated stainless steel filter 44 is disposed inside of a box 46 at the exterior feed end of the vessel 12. The interior of the box 46 is in communication with the interior of the wash basin 20 by a triangular cut out in the side of the vessel 12. The filtered water is then pumped back into the wash basin 20 via line 48. The filter 44 can be accessed for cleaning via removable lid 50, and the box 46 can be drained by opening drain valve 52. The filter 44 and the bottoms of the box 46 and the wash basin 20 are sloped to facilitate filtering and draining, respectively. Also, the bottoms of the rinse basin 22 and the overflow sump 32 are also sloped toward their respective drains.

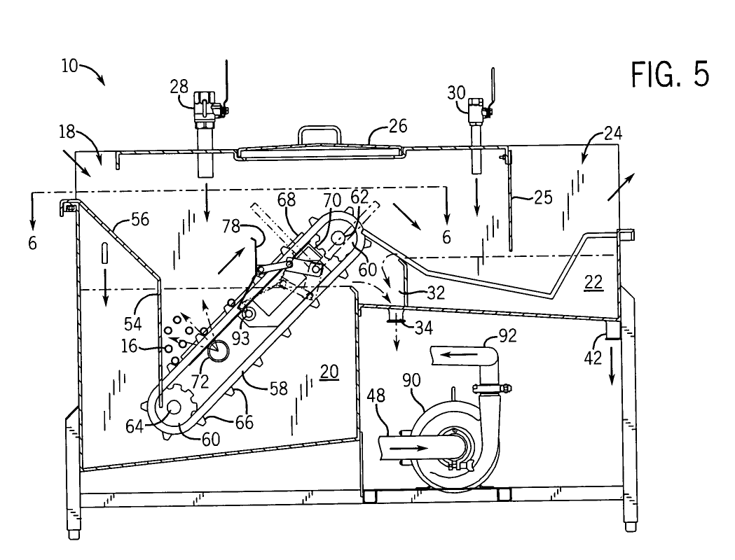

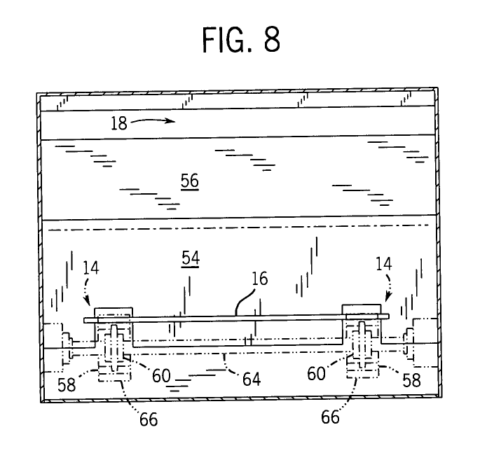

Referring to FIGS. 5 and 8, proper agitation and circulation of the objects 16 using only a single conveyor 14 is facilitated by a planar back stop 54 extending within the wash basin 20. The back stop 54 is preferably formed of a single stainless steel panel that bends to also define a load ramp 56, sloping downwardly at about a 45° angle from the open feed end of the vessel 12 to facilitate loading of the sticks 16. Below the bend, the back stop 54 extends straight down to be essentially vertical and perpendicular to the bottom of the vessel 12. The back stop 54 has a cut-out bottom side through which the lower end of the conveyor 14 protrudes.

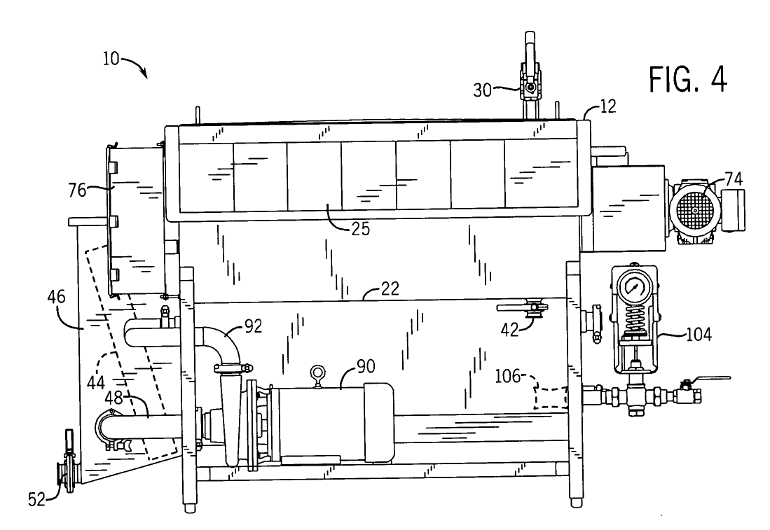

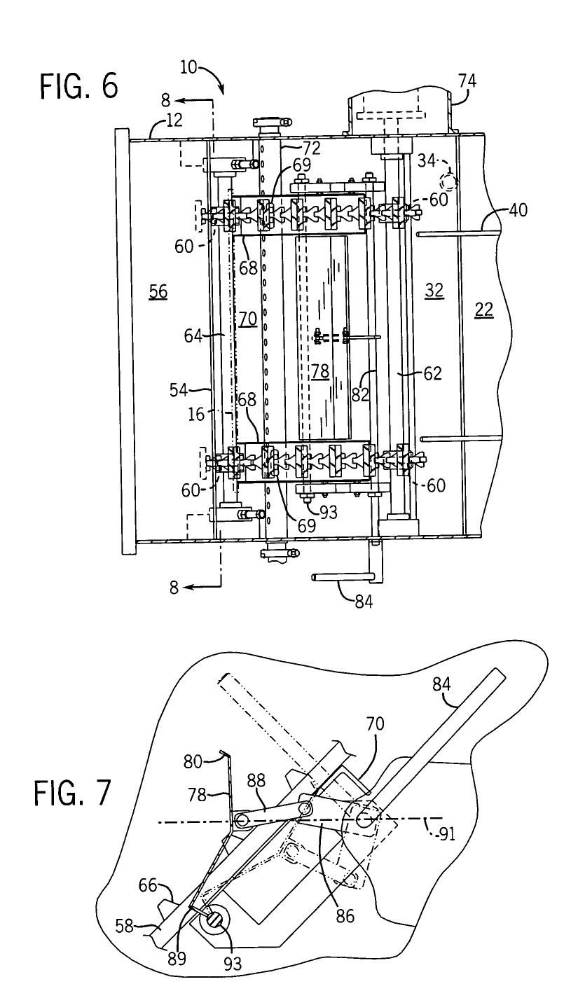

Referring to FIGS. 1, 5 and 6, the conveyor 14 includes a set of two closed loop conveyor chains 58 spaced apart and installed around sprockets 60 preferably mounted via adjustable bearings to a drive 62 and follower 64 conveyor shafts. The conveyor chains 58 are preferably polymeric but may be any acceptable material which is compatible with the cleaning solution. Each chain 58 has pusher flights 66 which act to engage the sticks 16 and both circulate them within the cleaning solution in the wash basin 20 and move them one at a time from the wash basin 20 to the rinse basin 22. Each chain 58 is supported by a channel 68 which is in turn supported by an angle member 70 and a jet manifold 72, which is part of the liquid circulation system described below. The channels 68 preferably include one or more slots or openings 69 for the cleaning solution to pass through. If necessary, an adjustable tensioner (not shown) can be included for each chain. Such tensioners can be in the form of spring loaded arms with a roller in contact with its respective chain, or the tensioners can have adjustable arms secured with a nut and bolt, as is known in the art. The conveyor 14 is propelled by applying power to the drive shaft 62 via motor 74 (see FIG. 2) mounted at the exterior of the vessel 12, which preferably has a variable speed so that the conveyor speed may be adjusted to suit the particular washing application. Operation of the motor 74 is controlled by a logic controller (not shown) contained in an electronics cabinet 76 mounted to the exterior of the vessel 12 (see FIGS. 2 and 4). The control cabinet 76 houses other the electrical components associated with the conveyor shaft motor, a pump motor and other electrical subsystems.

The conveyor shafts are preferably arranged so that the plane of the conveyor 14 and the back stop 54 form an angular section having an included angle of about 35° to about 60°. More preferred is an angle at or about has an angle of about 45°. And, preferably the conveyor 14 is about 35° to 50° degrees from the horizon, or the bottom of the vessel 12, the most preferred being about 45°. When the included angle between the back stop 54 and the conveyor 14 is significantly less than about 45°, the space for the stick pile is reduced thereby, not only making the pile smaller, but also making it narrower and taller and therefore less suitable for circulating the sticks properly. When the included angle is significantly more than about 45°, then the pile flattens too much and can cause the sticks to at the back of the pile (near the back stop 54) to stagnate rather than be circulated by the conveyor. Also, the reduction in depth of the stick pile diminishes the ability of the pile to hold the sticks on the conveyor against the force of the water from the jet manifold. Furthermore, the flattened stick pile may begin to move up the conveyor 14 collectively, rather than as individual sticks, thereby causing erratic mixing of the sticks and potential jamming at the flip back plate 78. When the angle of inclination of the conveyor 14 is significantly less than about 45°, such as below 35°, the sticks ejected from the conveyor 14 by the flip back plate 78 may fall short and land on the conveyor 14 rather than at the back of the pile as preferred, thus also causing erratic circulation and cleaning of the sticks.

Previously, it was thought that a separate infeed feed conveyor was necessary to pull the sticks 16 ejected from the conveyor 14 by the flip back plate 78 down toward the bottom the pile to ensure the sticks did not stagnate at the top of the pile. However, the inventors of the present invention have determined through empirical study that proper circulation of the sticks 16 could be achieved using only a single conveyor in combination with the back stop 54 of the disclosed configuration and location such that all of the sticks 16 could be adequately de-nested and cycled through the cleaning solution prior to rinsing.

Referring now to FIGS. 5-7, a movable flip back plate 78 is used to eject the sticks from the conveyor 14 during the washing cycle. The flip back plate 78 has a bent upper lip 80 to prevent the sticks 16 from riding up over the flip back plate 78. The flip back plate 78 is mounted via linkage to a flip back plate shaft 82, which is bounded by the chains 58 of the conveyor 14. Specifically, a handle 84 is fixedly connected to a crank arm 86 which is in turn pivotally connected to a connecting link 88 fixedly attached the flip back plate 78. Rotating the handle 84 (clockwise in FIG. 7) until the arm 86 hits angle 70 moves the flip back plate 78 to the extended position in which it protrudes above an upper plane formed by the chains 58 of the conveyor 14. In this position, the pivot point of the arm 86 and the arm 88 is located above a centerline 91 connecting the axis of the flip back plate shaft 82 and the pivot axis of the handle 84 such that the arm 86 and link 88 resist incidental retraction of the flip back plate 78 from contact with the sticks 16. In the retracted position, in which further rotation is prevented by contact of an upper part of the flip back plate 78 against angle 70, the flip back plate 78 is just below the upper plane of the conveyor chains 58. A lower bent down edge 89 is welded to another shaft 93 rotatably mounted to the conveyor support frame. The angle between the pusher flights 66 and the extended flip back plate 78 can be of any size as long as the sticks can be efficiently peeled off the conveyor 14 without the sticks hopping over the flip back plate 78. Preferably, the flip back plate 78 is essentially vertical when deployed and the face of the pusher flight 66 is beveled at about 30° so that the included angle is about 75°. These parameters have been determined to provide suitable operation without jamming of the sticks.

Referring again to FIGS. 1 and 2, the circulation system of the washer 10 includes a pump 90 located in the dry part of the vessel 12 beneath the bottom wall of the rinse basin 22. The pump 90 is connected by the suction line 48 to the exit of the strainer box 46 and by a discharge line 92 to the elongated jet manifold 72. The jet manifold 72 is bounded by the conveyor chains 58 and has a plurality of openings directed at the angular section between the conveyor 14 and the back stop 54. The jet manifold 72 directly impinges the cleaning solution near the lower adjacent side of the stick pile. Directing the jetstream near the bottom sticks provides for more effective cleaning because the weight of the pile of sticks holds the sticks against the force of the spray thereby allowing them to be sprayed forcefully without being pushed away from the conveyor.

Referring to FIGS. 2-4, a thermometer (not shown) is provided on the side of the vessel 12 which directly measures the temperature of the cleaning solution in the wash basin 20. Temperature control of the cleaning solution is accomplished by thermowell 102 which is operably connected to steam regulator 104. When the temperature of the cleaning solution falls below the desired set point, the steam regulator 104 will open allowing steam to be introduced into a steam mixer 106 mounted inside the vessel 12 and thereby heat the cleaning solution.

In use, the sticks 16 are loaded into vessel 12 through the open feed end 18. If not already done, the wash 20 and rinse 22 basins are filled with water and liquid cleanser is injected into the wash basin 20 through an injection port in a side wall of the vessel 12. Based on the temperature of the water, steam may also be injected into the wash basin 20. During operation of a wash cycle, the conveyor motor 74 is energized to turn the chains 58. The pusher flights 66 on the chains 58 pull sticks 16 off the bottom of the pile and conveys them upwards until they reach the flip back plate 78, which is placed in the extended position by manually rotating the handle 84. The extended flip back plate 78 peels the sticks 16 off the conveyor 14 and directs them back through the cleansing solution toward the back stop 54 and to the top of the pile of sticks 16 between the back stop 54 and the conveyer 14. The shearing action at the bottom of the pile tends to separate and de-nest the sticks. At the end of the timed wash cycle, the flip back plate 78 is retracted, by rotating the handle 84 in the opposite direction, and the sticks are conveyed out of the wash basin 20 by the conveyor 14 into the rinse basin 22. When all of the sticks have been transferred from the wash basin 20, the conveyor 14 is stopped. The washed and rinsed sticks are then removed from the vessel 12 by lifting the rinse rack 40 through the open exit end 24. Preferably, the cleaning solution is saved for the next batch of sticks. Overflowing wash or rinse water exits the vessel through the overflow sump 32 and out through its drain. Preferably, the wash basin 20 is topped up with water and possibly additional cleanser and the rinse basin 22 is drained and refilled prior to the next wash cycle.

An illustrative embodiment of the present invention has been described above in detail. However, the invention should not be limited to the described embodiment since many modifications and variations to the preferred embodiment, apparent to those skilled in the art, will be within the spirit and scope of the invention. For example, the washer could be supplied with an inlet hopper and inlet hopper door assembly (not shown) to better facilitate loading of the sticks. Also, the washer preferably includes a close out assembly having plates mounted to the vessel so as to close off the space between the chains of the conveyor to reduce the likelihood for sticks passing between the chains and beneath the conveyor. Therefore, to ascertain the full scope of the invention, the following claims should be referenced.

1. An apparatus for cleaning elongated objects comprising:
a cleaning tank having a feed end and an exit end formed by a top, a bottom and side walls sized to hold the elongated objects in a cleaning solution;
a back stop mounted inside the tank at the feed end and extending in the direction between the load ramp and the tank bottom; and
a single conveyor mounted inside the tank sloping upwardly from a lower end adjacent the back stop in the direction from the tank bottom toward the exit end so as to convey the elongated objects from the feed end to the exit end.

2. The apparatus of claim 1, wherein the back stop extends essentially perpendicular to the tank bottom.

3. The apparatus of claim 2, wherein the conveyor extends essentially at a 45° angle to the tank bottom.

4. The apparatus of claim 1, wherein the back stop and the conveyor extend along intersecting planes defining an angular section therebetween.

5. The apparatus of claim 4, wherein the angular section has an included angle of about 35° to about 60°.

6. The apparatus of claim 5, wherein the included angle is about 45°.

7. The apparatus of claim 1, wherein the conveyor has two spaced apart chains.

8. The apparatus of claim 7, wherein the chains include sets of aligned pusher flights extending from the conveyor at an angle.

9. The apparatus of claim 1, further including a plate mounted between the chains of the conveyor movable between a retracted position and an extended position above the conveyor.

10. The apparatus of claim 9, wherein at least the extended position of the plate is above a maximum fill level of the cleaning solution.

11. The apparatus of claim 10, wherein the tank further comprises an overflow for preventing the cleaning solution from exceeding the maximum fill level.

12. The apparatus of claim 1, further including a water jet mounted inside the tank to provide a jet stream between the back stop and the conveyor.

13. The apparatus of claim 1, wherein the exit end includes a rinse tank for receiving the elongated objects from the conveyor when the plate is in the retracted position.

14. The apparatus of claim 1, further including a load ramp mounted inside the tank at the feed end sloping downwardly in the direction from the feed end toward the tank bottom.

15. The apparatus of claim 1, wherein the elongated objects form a pile between the back stop and the conveyor and wherein a water jet is directed at one or more of the elongated objects below a top of the pile.

16. The apparatus of claim 15, further including a jet manifold having a plurality of openings facing the pile and producing the water jet.

17. An apparatus for cleaning elongated objects comprising:
a cleaning tank having a feed end and an exit end formed by bottom and side walls sized to hold the elongated objects in a cleaning solution;
a load ramp mounted inside the tank at the feed end sloping downwardly in the direction from the feed end toward the tank bottom;
a back stop mounted inside the tank at the feed end and extending in the direction between the load ramp and the tank bottom; and
a single powered continuous loop conveyor with at least two spaced apart chains adapted with push flights for supporting and conveying the elongated objects from the feed end toward the exit end, the conveyor having a proximal end adjacent the back stop wound around a first shaft and a distal end at the exit end of the tank wound around a second shaft so as to be mounted inside the tank sloping upwardly in the direction from the tank bottom toward the exit end; and
a plate mounted between the conveyor chains and movable between a retracted position in which elongated objects carried by the conveyor can be delivered to the exit end and an extended position above the conveyor in which elongated objects carried by the conveyor contacting the plate are stripped from the conveyor and returned to the feed end between the back stop and the conveyor.

18. The apparatus of claim 17, wherein the back stop extends essentially perpendicular to the tank bottom.

19. The apparatus of claim 18, wherein the conveyor extends essentially at a 45° angle to the tank bottom.

20. The apparatus of claim 17, wherein the back stop and the conveyor extend along intersecting planes defining an angular section therebetween.

21. The apparatus of claim 20, wherein the angular section has an included angle of about 35° to about 60°.

22. The apparatus of claim 21, wherein the included angle is about 45°.

23. The apparatus of claim 17, wherein at least the extended position of the plate is above a maximum fill level of the cleaning solution.

24. The apparatus of claim 17, wherein the tank further comprises an overflow for preventing the cleaning solution from exceeding the maximum fill level.

25. The apparatus of claim 17, further including a water jet mounted inside the tank to provide a jet stream between the back stop and the conveyor.

26. The apparatus of claim 17, wherein the exit end includes a rinse tank for receiving the elongated objects from the conveyor when the plate is in the retracted position.

27. The apparatus of claim 17, wherein the elongated objects form a pile between the back stop and the conveyor and wherein a water jet is directed at one or more of the elongated objects below a top of the pile.

28. The apparatus of claim 27, further including a jet manifold having a plurality of openings facing the pile and producing the water jet.

29. A method of cleaning elongated objects comprising:
feeding the elongated objects to the apparatus of claim 1;
operating the conveyor with the plate in the extended position for a predetermined time; and
delivering the elongated objects to a rinse tank at the exit end of the tank by placing the plate in the retracted position; and
removing the elongated objects from the rinse tank.
